(19) United States
(12) Patent Application Publication
(10) Pub. No.: US 2016/0354629 A1
(43) Pub. Date: Dec. 8, 2016

(54) PORTABLE RESISTANCE EXERCISE DEVICE

(71) Applicant: Stuck In Bed Fitness Solutions, LLC, Beachwood, OH (US)

(72) Inventors: Joseph M. Salamon, Beachwood, OH (US); Samuel M. Salamon, Beachwood, OH (US); Vladimir Feldman, Lyndhurst, OH (US)

(21) Appl. No.: 15/170,927

(22) Filed: Jun. 1, 2016

Related U.S. Application Data
(60) Provisional application No. 62/170,034, filed on Jun. 2, 2015.

(51) Int. Cl. A63B 21/04; A47C 4/00; A47C 1/00; G09B 5/02; G09B 19/00

(52) U.S. Cl. CPC A63B 21/04; G09B 5/02; G09B 19/003; A47C 1/00; A47C 4/00; A63B 2210/50

(57) ABSTRACT

A portable exercise device is described. The device includes a collapsible chair and resistance cables selectively connected to the chair. The device can be manipulated between an extended configuration for performing exercises, and a collapsed configuration for transport or storage. The resistance cables are attached to the chair by being fed through or otherwise engaging apertures in the chair. The apertures may be defined by the chair frame members, holes extending through the frame members, brackets attached to the frame members, or channels near the frame members.

### FIELD

The present invention relates to a multi-function exercise device that can be easily and conveniently transported for use.

### BACKGROUND OF INVENTION

Exercise devices are provided in a variety of sizes, styles, and means of providing exercise for an individual. The most useful exercise devices provide some means of resistance against which muscle exercises are performed. Resistance is provided in a variety of ways, from lightweight to heavy resistance. Most conventional exercise machines are built on solid, stable, and robust frames that are intended to be kept at one location, and which require more than one person to move due to their weight and size. These conventional exercise machines are referred to herein as “stationary” machines.

When not at a location (e.g. a fitness club) that has such stationary exercise machines, it is often difficult to engage in strength training. Moreover, it is often difficult to dedicate an adequate amount of time to visit such exercise facilities. This is because people are often in transit in a car, bus, or train between one location and another (e.g. between home and work), or at a location that does not have stationary exercise devices, such as a park or at home. In these situations, people often do not participate in exercise or strength training. Accordingly, fitness and range of motion suffer.

### SUMMARY OF THE INVENTION

The present invention is directed to a portable resistance exercise device or system that can be easily transported from one location to another by a single individual. As used herein, the terms “portable,” “easily transported,” and cognate terms refer to a device that has a weight and size such that it does not require more than one person to move it from one location to another. Instead, the device that is portable can be moved by hand or otherwise, by one person without assistance from others or from a lifting machine.

The portable resistance device of the present invention comprises a collapsible chair to which one or more cables or resistance bands is connected. The portable device is adapted to be placed/mounted on a surface, for example on a bench, chair, bleacher, sofa, a regular chair with legs, or even on the floor or ground. The chair serves as a base for resistance exercises, which can be performed when a user is seated on the chair.

The portability of the device allows a user to easily transport the device to virtually any location or venue, and thereby engage in strength training even when outside the confines of an exercise facility and even when there is no access to traditional stationary exercise machines. The device can be easily transported to, and used at almost any location where the device can be placed on a surface and a user can sit on the device. For example, the device can be used at a bus stop, train station, airport, waiting room, office, restaurant, theater, auditorium, in a vehicle, home, or even on the ground.

The present invention also provides a program of exercises (e.g. as contained in an instructional video) that can be performed using the device to improve fitness, strength, range of motion, and psychological wellbeing through exercise. The present invention provides numerous exercise and strength training opportunities at locations where there is no access to conventional stationary exercise machines.

In one embodiment, the present subject matter provides a portable exercise device including a collapsible chair and one or more variable resistance cables selectively connected to the chair. The chair is configured to be placed upon a surface and comprising a seat base, a seat back, and two arms. The chair is configured to be selectively manipulated between an extended configuration and a collapsed configuration. When in the extended configuration, the chair is configured such that the seat base contacts the surface upon which the chair is placed, an angle between the seat back and the seat base is between 80 degrees and 130 degrees, and the two arms extend between the seat base and seat back. When in the collapsed configuration, an angle between a plane occupied by the seat back and a plane occupied by the seat base is between 0 degrees and 20 degrees.

In another embodiment, the present subject matter provides an exercise kit comprising a portable exercise device, a hand strengthening device, padded gloves, and an exercise ball. The portable exercise device includes a collapsible chair and one or more variable resistance cables selectively connected to the chair. The chair is configured to be placed upon a surface and comprising a seat base, a seat back, and two arms. The chair is configured to be selectively manipulated between an extended configuration and a collapsed configuration. When in the extended configuration, the chair is configured such that the seat base contacts the surface upon which the chair is placed, an angle between the seat back and the seat base is between 80 degrees and 130 degrees, and the two arms extend between the seat base and seat back. When in the collapsed configuration, an angle between a plane occupied by the seat back and a plane occupied by the seat base is between 0 degrees and 20 degrees

The foregoing and other features of the invention are hereinafter more fully described below, the following description setting forth in detail certain illustrative embodiments of the invention, these being indicative, however, of but a few of the various ways in which the principles of the present invention may be employed.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

With reference to the accompanying drawing figures, please note that:

FIG. 1 is a perspective view of a portable exercise device in an extended configuration in accordance with the present subject matter.

FIG. 2 is a perspective view of a portable exercise device in a position between the extended configuration and a collapsed configuration in accordance with the present subject matter.

FIG. 3 is a perspective view of a portable exercise device in a collapsed configuration in accordance with the present subject matter.

FIG. 4 is a perspective view of a portable exercise device in an extended configuration and placed upon a surface in accordance with the present subject matter.

FIG. 5 is a perspective view of a portable exercise device in an extended configuration in accordance with the present subject matter.

### DETAILED DESCRIPTION OF THE INVENTION

The present invention includes a portable exercise device or system comprising a collapsible chair and variable resistance cables attached thereto. The system can be transported from place to place quickly and easily when in a collapsed configuration, and when in an extended configuration, it can be placed on a surface, such as on a bench, bleacher, car seat, train seat, bus seat, airplane seat, bus stop seat, boat/ship seat, chair, sofa, space module seat, submarine seat, or the like and used for exercise.

The device can be used by people of all ages and at all levels of fitness. It will be particularly beneficial to those who find themselves routinely waiting at bus stops, train stations, airports, waiting rooms or who find themselves as spectators at professional and amateur sporting events, or those simply riding in a vehicle. Because very strong resistance can be provided if desired, even trained and toned athletes can use the compact and portable device and associated method to maintain and improve strength and range of motion.

The device can be utilized by persons in wheelchairs, by truck drivers, train and bus riders, office workers, etc. Users benefit in many ways, as can all athletes/fitness enthusiasts/moms on the go. This device and kit are also useful for recovery, or rehab therapy on the go or at home. The device and kit can be used by the enabled and disabled by providing exercise and fitness on the go.

### Collapsible Chair

The portable exercise device includes a collapsible chair, which includes a seat base, a seat back, and optional arms. The collapsible chair is configured to be selectively manipulated between an extended configuration for use in exercising, and a collapsed configuration for easy transport and storage.

When in the extended configuration, the chair is configured to be placed on a surface and sat upon by a user, wherein the user sits upon the seat base. In several embodiments, the chair is secured, or substantially so, relative to the user by the user's own weight bearing down upon the chair. In one aspect, the chair is secured to the surface, e.g. by straps, to inhibit movement of the chair relative to the surface. For example, the chair may be secured to a surface, e.g. a regular household chair having legs, by using one or more straps that wrap around the household chair and secure the portable exercise device to the household chair. The straps may include a clip for securing two ends of the straps together. This may inhibit movement of the exercise device during use. The surface upon which the chair is placed or secured can be horizontal, or substantially so, or can be slightly angled from horizontal, e.g. from zero up to angles of about 35 degrees from horizontal. The surface can include for example, a regular household or office chair, a bench, a bleacher, a sofa, or even the floor or the ground.

When in the extended configuration, the chair comprises a substantially horizontal seat base and a substantially vertical seat back, such that the seat base and seat back have an angle between them of from about 80-130 degrees, 85-120 degrees, 90-110 degrees, 95-105 degrees, or about 100 degrees. In one aspect, the seat base and seat back form an L-shape, or substantially so.

The seat base and seat back can comprise one or more rigid frame members, wherein material is extended between the frame members to provide the seat base and seat back of the chair. The seat base and seat back can be made from the same or different material, and can include metal, polymer (including foam), fabric, ceramic, glass, wood, a composite material (including gel), or combinations thereof. In one embodiment, the seat base includes a foam or cushioning material for providing comfort to a user when sitting in the chair. In one embodiment, the seat back includes a fabric material extending between frame members.

The shape of the seat back and seat base are not particularly limited and can be the same or different between the seat back and seat base. In one embodiment, the seat back and seat base each define a square or rectangle shape. The size of the seat back and seat base are not particularly limited and can be sized as desired.

In several embodiments, the chair also includes one or more arms, and preferably two arms. The arms may be positioned on either side (i.e. two side edges) of the chair and extend between the seat base and the seat back. The arms may be optionally connected to one or both of the seat base and the seat back, and may be used to register, support, and/or secure the seat base relative to the seat back. In several embodiments, the arms are configured to have resistance cables or bands attached thereto. In another aspect, the arms do not extend between the seat base and the seat back, but instead are connected only to the seat base or only to the seat back. The shape of the arms is not particularly limited by the present subject matter, and can be an L-shape, I-shape, U-shape, or any other shape as desired. The arms can be rigidly or moveably secured to the seat back, the seat base, or both. The arm can be made from the same or different materials as the seat back or seat base. In one embodiment, the arms comprise metal tubing.

In several embodiments, the chair includes apertures configured to allow the resistance cables or bands to be secured relative to the chair, e.g. to the arms. The apertures are used to connect the resistance cables or bands to the chair, for example by feeding the resistance cables or bands through the apertures. The apertures may be defined by a complete frame around the apertures (e.g. a ring), an open frame around the apertures (e.g. a hook), a complete frame around the apertures that has a moving part to open the frame to access the apertures (e.g. spring/snap hook, or carabiners), or combinations thereof.

The apertures may be formed integrally to the seat base, seat back, or arms; such as holes, eyelets, loops, or channels formed in or by the seat base, seat back, or arms. The apertures may also/alternatively be formed as separate pieces to the seat base, seat back, or arms; such as brackets, rings, hooks, or other attachment mechanisms secured to the seat base, seat back, or arms.

The location of the apertures in not specifically limited, and may be formed anywhere on the chair as desired. In one aspect, the arms include apertures. For example, brackets may be located on an inside surface of the arms, or holes may be formed through the arms. Similar apertures can be included in the seat base and/or seat back, such that the resistance cables or bands can be attached to the seat base and/or seat back.

In one embodiment, the arms are upside down U-shaped arms, and the chair includes brackets attached to an inside surface of the U-shaped arms. When a user sits in the chair, the brackets therefore do not come into contact with the user, such as might happen if the brackets were attached to an outside surface of the U-shaped arms.

In several embodiments, when the chair is in the extended configuration, the seat back extends up from the seat base to a height that is at, or under the shoulders of an average-sized user when the user is seated on the seat base and not slouching. In these embodiments, the chair may further include a seat back panel that is connected to the seat back. The seat back panel may be hingedly, telescopically, or slidingly connected to the seat back such that the seat back panel can be selectively moved to an extended position. When the chair is in the extended configuration, the extended seat back panel extends up from the seat back to a height (e.g. over the shoulders of a user) that is greater than the height of the seat back.

In one aspect, the seat back panel includes apertures to which resistance cables or bands can be secured relative to the chair. In this way, resistance cables can be attached to the seat back panel, such that the attachment position for the resistance cables is elevated over the shoulders of a user, thereby allowing more diverse physical exercises and also providing increased support for the user's back, neck, or head. When it is desired to collapse the chair for transport or storage, the seat back panel can be selectively moved to a retracted position, such that the seat back panel does not extend to a height greater than the height of the seat back.

In several embodiments, the seat base and the seat back are operatively connected to each other, such that the chair can be moved/manipulated between the extended configuration and the collapsed configuration. The movement of the seat base relative to the seat back can be accomplished through the use of a hinged or rotating connection between the seat base and seat back, and/or within or as part of the seat base and seat back. In several embodiments, the seat base and seat back can be moved towards each other from an extended L-shaped configuration to a collapsed configuration that is more flat, and thus more compact, wherein the seat back and seat base are parallel to each other, or substantially so, or lie within the same plane. In one embodiment, when in the collapsed positions, an angle between the seat back and seat base is between 0-20 degrees, 0-10 degrees, or 0-5 degrees, or zero degrees.

When in the collapsed configuration, the chair has a smaller, more compact profile or footprint, and therefore can be easily carried, stored, and transported. In several embodiments, the collapsed configuration comprises the chair being in a folded arrangement. The collapsed configuration may also be realized by folding or bending the seat back, the seat base, or both.

In one embodiment, the seat base is formed by two hinged seat base portions, which may be moved relative to each other about the hinge, wherein the upper surfaces of the two hinged seat base portions are moved into a face-to-face arrangement, thereby manipulating the chair between the collapsed configuration and the extended configuration. When in the extended configuration, the two seat base portions substantially occupy the same plane. When in the collapsed configuration, the two seat base portions are in a folded arrangement and do not occupy the same plane.

In another embodiment, the collapsed configuration may be realized by moving the seat back relative to the seat base, e.g. by folding the seat back closer to the seat base.

In several embodiments, the device includes one or more carrying implements, such as straps, handles, or belts for carrying the device by hand, over the shoulder(s), or otherwise by a user. The strap or handle may be integral with, or connected to the seat base, seat back, arms, or a combination thereof.

In one embodiment, the device includes a buckle, strap, snap or the like, or combinations thereof for securing the chair in the collapsed configuration and/or in the extended configuration.

In several embodiments, the collapsible chair does not have legs for providing separation between the seat base and the surface upon which the chair is placed, thereby allowing the seat base to be placed directly in contact with the surface. That is, when the chair is in the extended position and placed on a surface in an upright position that allows a user to sit on the seat base, the seat base contacts the surface. In one embodiment, the chair is without legs. In another embodiment, the chair includes relatively short legs having a length such that both the legs and seat base contact the surface upon which the chair is placed.

### Resistance Bands

The portable exercise device includes one or more resistance bands or cables selectively attached to the collapsible chair. In several embodiments, the device includes an assortment of resistance bands or cables for providing multiple exercises for upper and lower limbs of a user, and depending on length of cables provides a desired amount of resistance. The assortment of resistance cables may be coded (e.g. by color) according to pounds of resistance provided.

Preferably, one or more resistance cables with hand grips and/or latex free elastic bands are attached to the collapsible chair (e.g., from the arms, seat base, seat back, seat back panel, or other frame elements). The hand grips can be selectively removed from one set of cables and selectively attached to another set of cables.

Cables and/or bands providing variable resistance can be utilized. The cables and/or bands connected to the chair can be adjusted in length or used in pairs or other combinations to adjust resistance. Variable lengths of the cables and bands are envisioned, allowing a user to exercise upper limbs and lower limbs with resistance provided by the cables and bands. Multiple bands or cables may be attached to the chair at the same time, so that different or multiple exercises could be performed, or so that they may be paired or ganged to increase resistance during a particular exercise.

The resistance cables and bands may be selectively or permanently anchored to any portion of the chair. For example, the resistance cables and bands may be attached to the seat base, seat back, seat back panel, arms, or combinations thereof. In one embodiment, the resistance bands are selectively attached to the chair, and therefore may be selectively detached from the chair and re-attached to the chair at a different location. Moving the connection position of the resistance bands from one location on the chair to another, may allow a user to perform different exercises or increase resistance between the two connection positions. Moving the connection positions may be accomplished for example, by attaching the resistance bands to different apertures in the chair. In several embodiments, the resistance cables and bands are wrapped around, or fed through apertures in the seat base, seat back, seat back panel, arms, or combinations thereof.

The resistance cables may include an anchor, for connecting the resistance cable to the chair. For example, the anchor may comprise a pin, hook, or other attachment mechanism that cooperates with an aperture in the chair to connect the resistance band to the chair.

### Kit

In several embodiments, the portable exercise device is provided as part of a kit of materials. The kit can further comprise one or more hand strengthening devices such as, for example small compressible balls with varied levels of resistance that can be used with different grips to increase finger, hand, and wrist strength.

The kit can further comprise one or more selected from the group consisting of padded gloves, and a Pilates ball. The kit can also include an instructional DVD, which shows how to assemble and use the device to perform various exercises. Additional information can be provided via an associated web site, which offers a choice of consultation regarding nutrition, exercise, astrology, and general support to users of the device and kit. The kit can include a carrying case or bag.

Exercises that can be performed using the device and kit include, but are not limited to (the muscles or groups strengthened by the exercise are also identified), Shoulder Raises—anterior and lateral deltoids; Lateral Raises—lateral deltoid; Triceps Extension With Pull-down—triceps and seat back of arm; Front Raise—anterior deltoid; Two Arm Triceps Push-down—triceps (lateral head); Two Arm Row—mid seat back; rhomboids; Biceps Curls With Overhand Grip—biceps; Straight Arm Cable Crossover—pectoralis major (chest); Single Arm Isolation Curl—biceps; Underhand Fly—pectoralis major, biceps; Biceps Curl With Single Leg Press Down—biceps, quads, core; Internal And External Hip Rotation With Bent Knee—abductors and adductors; Leg Hamstring Curl—hamstrings; Biceps Curl Into Upper Cut—biceps, pectoralis major, core; Forward Punch—anterior deltoid, pectoralis major; External Shoulder Rotation—rear delts, rhomboids, trees minor (part of rotator cuff); Shoulder Press—anterior and lateral deltoids; Two Arm Row—mid seat back; Crunch With Twist—obliques, rectus abdominus; Reverse Cable Crossover—lats, rhomboids, core; Isolated One Arm Triceps Push-down—triceps; Seat based Twist—obliques, rectus abdominus; and Two Arm Biceps Curl With Neutral Grip—biceps.

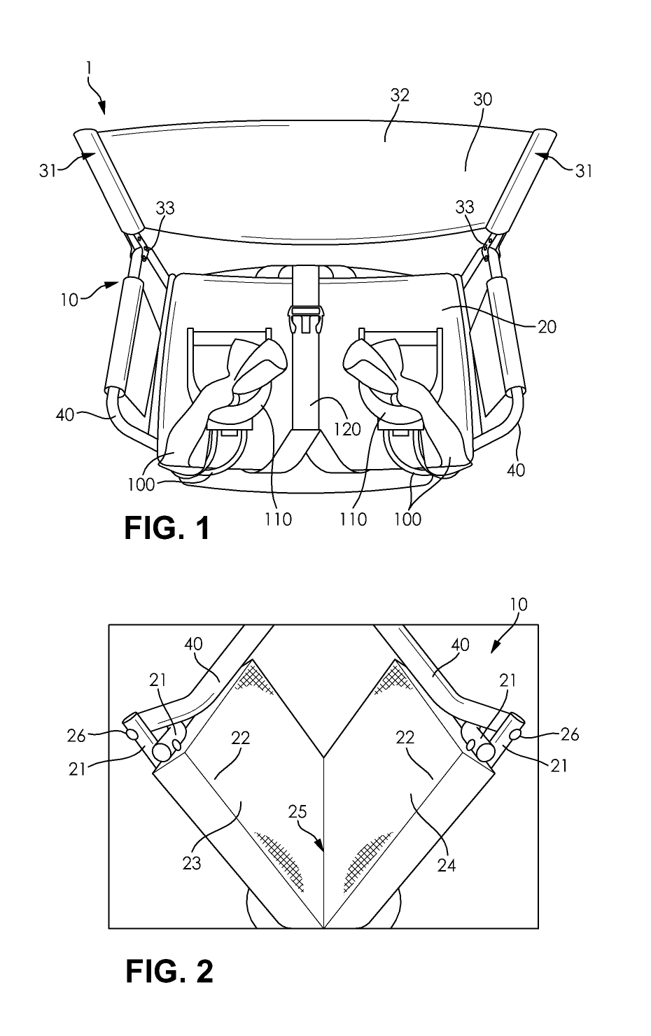

With reference to FIGS. 1-5, the portable exercise device 1 according to the invention comprises a collapsible chair 10 and variable resistance cables 100 attached thereto. In a preferred embodiment as shown, the collapsible chair 10 comprises a seat base 20 and a seat back 30, which are connected in such a way as to allow the chair 10 to be selectively manipulated between an extended configuration (FIG. 1) for use in exercising, and a collapsed configuration (FIG. 2) for compact carry and storage. The collapsible chair 10 further comprises arms 40, to which resistance devices, e.g. variable resistance bands or cables 100, are selectively attached.

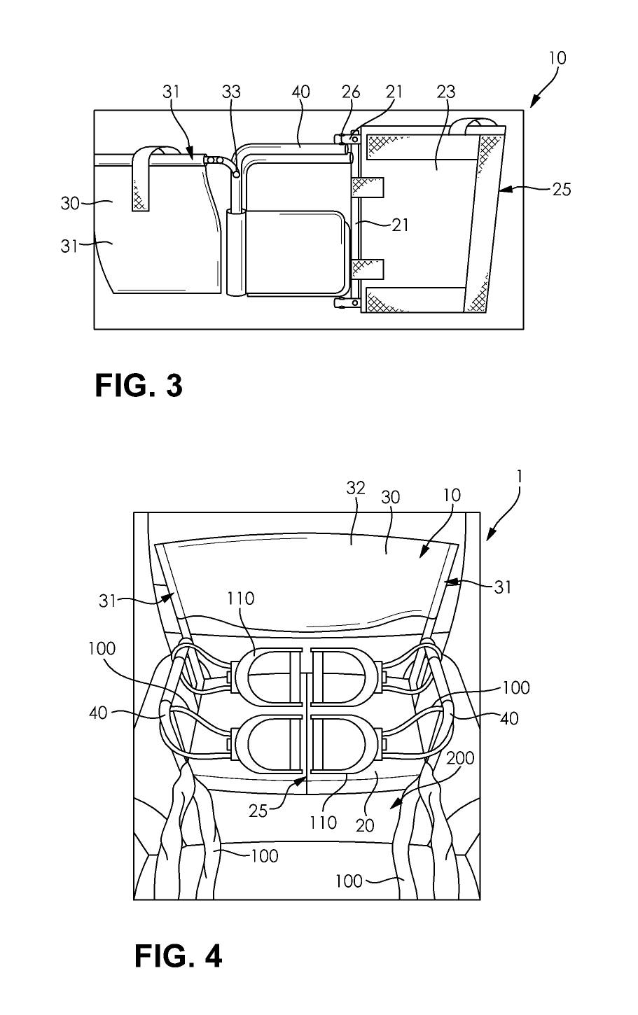

As shown, the seat base 20 includes rigid frame members 21 and a padded or cushioning member 22 extending between the frame members to thereby define the seat base 20. The seat base 20 further comprises two seat base portions 23, 24 that are connected at a hinge 25, such that they can be in substantially the same plane when the chair 10 is in the extended configuration (FIG. 1), yet fold towards each other (FIG. 2-3) to place the chair 10 in the collapsed position (FIG. 3).

The seat back 30 is shown to comprise two rigid frame members 31 (e.g. metal tubing) on either side of the chair 10, and having fabric 32 stretched therebetween to thereby define the seat back 30. As shown in FIG. 1, the frame members 31 extend up from the arms 40 and are connected by two hinges 33 to the arms 40, such that the seat back 30 can fold toward the seat base 20.

The arms 40 are shown to comprise U-shaped rigid frame members that are connected to, and extend between the seat base 20 and the seat back 30. The seat base 20 is connected by hinges 26 to the arms 40 such that when the two seat base portions 23, 24 are moved to face each other (FIG. 2), the two arms 40 can be moved out of the way to thereby allow the two seat base portions 23, 24 to a face-to-face configuration and to allow the chair 10 to enter the collapsed configuration (FIG. 3).

The cables 100 are shown to include various elastic bands, with and without hand grips 110. Although shown in FIGS. 1 and 4 to be attached to the arms 40, it will be understood that the cables can be attached to other portions of the chair 10, including the seat base 20, seat back 30, and seat back panel as described herein.

As shown in FIG. 4, the chair 10 is configured to be placed on a substantially horizontal surface 200 (e.g. a regular household chair), wherein the seat base 20 contacts the surface 200. As will be understood, a user sits on the seat base 20, which rests upon and contacts the surface 200. The user's back may also rest against the seat back 40. When seated, the user can then perform various exercises using the resistance bands 100 of the device 1. When finished with exercising, a user can fold the chair 10 into the collapsed configuration (FIG. 3) and easily store or transport the device 1 as desired.

As shown in FIG. 1, the chair 10 includes a strap 120, which may be used to carry the device 1 and/or for securing the chair 10 to a surface, e.g. a regular household chair having legs, by wrapping the strap 120 around the household chair to secure the portable exercise device 1 to the household chair.

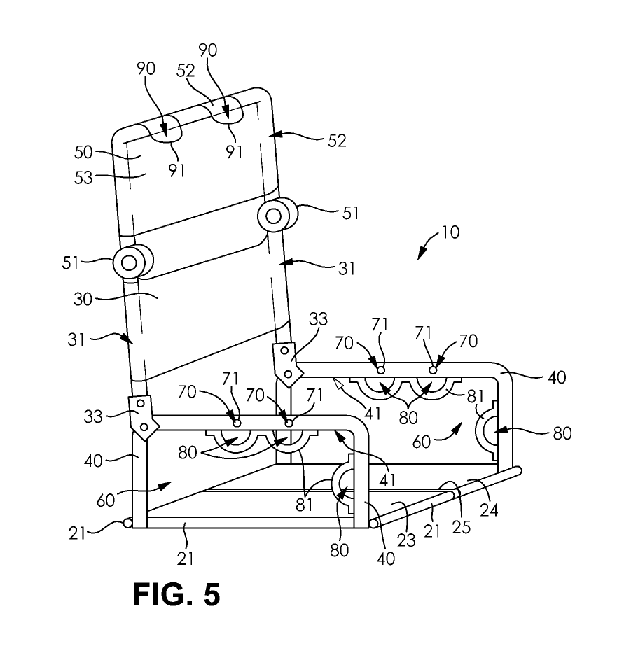

As shown in FIG. 5, the chair 10 can further include a seat back panel 50 that is connect by hinges 51, or otherwise, to the seat back 30. The seat back panel 50 includes a frame member 52 having fabric 53 stretched therebetween to thereby define the seat back panel 50. The frame member 52 may include a hinge (not shown) at the center top of the frame member 52 to allow the frame member to collapse when the chair 10 is folded to the collapsed configuration. When in the extended position shown in FIG. 5, the seat back panel 50 extends to a height that is higher than the seat back 30. The seat back panel 50 can be selectively rotated about the hinges 51 to a retracted position.

As shown in FIG. 5, the chair 10 includes various apertures formed by, in, or on the various parts of the chair 10, and which are used to connect the cables 100 to the chair 10. As seen, apertures 60 are formed by the arms 40 themselves. Apertures 70 are formed by holes or bores 71 extending through the arms 40. Apertures 80 are formed by U-shaped and W-shaped brackets 81 attached to the inside surface 41 of the arms 40. The brackets 81 can be welded to the arms 40, bolted or screwed to the arms 40, or otherwise secured to the arms 40 as desired. As seen, apertures 90 are included as part of the seat back panel 50, and are formed by channels 91 in the fabric 53 of the seat back panel 50.

As discussed herein, the cables 100 can be fed through any of the apertures 60, 70, 80, 90 to selectively attach the cables 100 to the chair 10. Alternatively, the cables 100 can include anchors or fasteners (not shown), such as hooks, clips, cotter pins, screws, snaps, detent pins, quick-release pin, or the like, which can be configured to engage the apertures 60, 70, 80, 90 for selectively attaching the cables 100 to the chair 10.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A portable exercise device including a collapsible chair and one or more variable resistance cables selectively connected to the chair, the chair being configured to be placed upon a surface and comprising a seat base, a seat back, and two arms, wherein:
the chair is configured to be selectively manipulated between an extended configuration and a collapsed configuration,
when in the extended configuration, the chair is configured such that the seat base contacts the surface upon which the chair is placed, an angle between the seat back and the seat base is between 80 degrees and 130 degrees, and the two arms extend between the seat base and seat back, and
when in the collapsed configuration, an angle between a plane occupied by the seat back and a plane occupied by the seat base is between 0 degrees and 20 degrees.

2. The device according to claim 1, wherein the cables are selectively connected to the arms.

3. The device according to claim 1, wherein the chair includes one or more apertures configured to allow the cables to be selectively connected to the chair.

4. The device according to claim 3, wherein the cables are fed through the apertures to thereby selectively connect the cables to the chair.

5. The device according to claim 3, wherein the apertures are formed in the arms.

6. The device according to claim 5, wherein the apertures are defined by one or more holes formed through the arms.

7. The device according to claim 2, wherein the apertures are defined by one or more brackets connected to the chair.

8. The device according to claim 7, wherein the brackets are connected to inside surfaces of the arms.

9. The device according to claim 1, wherein the cables each include an anchor selectively connecting each cable to the chair.

10. The device according to claim 3, wherein the cables each include an anchor configured to selectively engage the apertures.

11. The device according to claim 1, further comprising a seat back panel operatively connected to the seat back, such that when the chair is in the extended configuration and the seat back is in a substantially vertical orientation, the seat back panel can be selectively moved to a height greater than the seat back.

12. The device according to claim 11, wherein the seat back panel includes apertures configured to allow the cables to be selectively attached to the seat back panel.

13. The device according to claim 1, wherein:
the seat base includes two seat base portions operatively connected by a hinge such that the two seat base portions can be moved relative to each other,
when in the extended configuration, the two seat base portions substantially occupy the same plane,
when in the collapsed configuration, the two seat base portions are in a folded arrangement and do not occupy the same plane.

14. The device according to claim 1, further comprising a carrying implement configured to allow the device to be transported by hand or on a shoulder, and selected from the group consisting of a handle, a strap, a belt, or combinations thereof.

15. The device according to claim 1, wherein the chair does not includes legs that provide separation between the seat base and the surface upon which the chair is placed.

16. The device according to claim 1, wherein the cables include an assortment of cables having differing resistance levels.

17. The device according to claim 1, wherein the cables include removable hand grips for gripping the cables by hand.

18. The device according to claim 1, wherein the cables comprise elastic bands.

19. An exercise kit comprising a portable exercise device, a hand strengthening device, padded gloves, and an exercise ball, wherein:
the portable exercise device comprises a collapsible chair and one or more variable resistance cables selectively connected to the chair, the chair being configured to be placed upon a surface and comprising a seat base, a seat back, and two arms, wherein:
the chair is configured to be selectively manipulated between an extended configuration and a collapsed configuration,
when in the extended configuration, the chair is configured such that the seat base contacts the surface upon which the chair is placed, an angle between the seat back and the seat base is between 80 degrees and 130 degrees, and the two arms extend between the seat base and seat back, and
when in the collapsed configuration, an angle between a plane occupied by the seat back and a plane occupied by the seat base is between 0 degrees and 20 degrees.

20. The kit according to claim 19, further comprising an instructional video describing how to use the kit to perform exercises.
